(19) United States
(12) Patent Application Publication
(10) Pub. No.: US 2015/0331258 A1
(43) Pub. Date: Nov. 19, 2015

(54) TTL ADJUSTABLE BINOCULAR LOUPES DEVICE

(71) Applicant: Manmit Singh MATHARU, Dartford, Kent (GB)

(72) Inventor: Manmit Singh MATHARU, Dartford, Kent (GB)

(21) Appl. No.: 14/435,691

(22) PCT Filed: Oct. 3, 2013
(86) PCT No.: PCT/GB2013/052579

§ 371 Date: Apr. 14, 2015

(30) Foreign Application Priority Data
Oct. 3, 2012 (GB) 1217675.6

(51) Int. Cl. G02C 7/08

(52) U.S. Cl. CPC G02C 7/088

(57) ABSTRACT

A through-the-lens (TTL) adjustable binocular loupes device (100) comprising a spectacle-like frame (102), first and second support elements (104, 106), first and second adjustable TTL loupes (108, 110) pivotably supported by the first and second support elements (104, 106) respectively. The support elements (104, 106) are slidably mounted for linear movement thereof, and therefore the loupes (108, 110), relative to the rim (116) of the frame (102). Infinite adjustment mechanisms (200, 156, 158) are provided for effecting infinite adjustment of the loupes (108, 110) linearly along a first axis relative to the rim (116), and pivotally about a second, horizontal and third, vertical axis respectively.

This invention relates to a through-the-lens (TTL) adjustable binocular loupes device and, more particularly, but not necessarily exclusively, to such a loupes device for dentists and surgeons.

A loupe, also known as a hand lens or nose lens, is a known magnification device which, unlike a conventional magnifying glass, is typically devoid of a handle and, therefore, requires the lens body to be supported or otherwise grasped by, for example, the user's hand. However, for professionals such as surgeons, dentists, vets and jewellers, this can be problematic, since both hands are typically required when working.

It is therefore known to provide two loupes which are supported by a spectacle-like frame. This can be achieved in two ways. The loupes can be held within a separate support which is then mounted to the frame, allowing the support with the loupes to be pivoted down in front of the lens portion of the frame when needed, and pivoted up out of the way when not required. The support may also be detachable from the frame, leaving the lens portion intact.

The second known arrangement is to provide each calibrated loupe within a lens portion of a spectacle-like frame. This arrangement is typically bespoke to the user, with the loupes being fixed, typically by means of adhesive or the like, in the frame at the correct position for the specific user, as defined by measurements provided by the user to the supplier.

The first known arrangement provides limited adjustability but, because of the nature of the adjustment means, the loupes sit too far from the user's pupils, resulting in non-optimal optical characteristics in use.

The second known arrangement is beneficial, since the loupes are closer to the user's pupils in use, thereby providing improved optical characteristics. However, there is no available adjustability. Therefore, each set of loupes made is only optimally suitable for use by the user whose measurements were used to define the positioning of the loupes within the support.

Thus, in accordance with a first aspect of the present invention, there is provided a through-the-lens (TTL) adjustable binocular loupes device, comprising a head-mountable frame, a support element and at least one TTL loupe mounted on said support element and movable relative to said frame along a first axis between first and second limits, the device further comprising an infinite adjustment mechanism for moving said loupe to any desired position between said first and second limits, and means for fixing said loupe in said desired position.

In a preferred embodiment, said at least one loupe is linearly moveable relative to said frame along said first axis. In a more preferred embodiment, said at least one loupe is pivotable relative to said frame about a second axis between first and second limits, and optionally pivotable about a third axis, substantially perpendicular to said second axis, between first and second limits, the device further comprising an infinite adjustment mechanism for moving said at least one loupe to any desired position between said first and second limits on said second axis and/or said third axis, and means for fixing said loupe in said desired position.

Preferably, the device is provided with two TTL loupes, each linearly moveable along said first axis and/or pivotable about said second and third axes, the infinite adjustment mechanism being configured for moving each of said loupes to any desired position between said first and second limits on the or each of said respective axes and fixing said loupes in said respective desired positions.

In one exemplary embodiment of the present invention, the adjustment mechanism comprises a sleeve having an internal screw-threaded surface, the sleeve being connected to the at least one loupe and being mounted on said frame or support element for movement along one of said first, second or third axes, said sleeve comprising an opening for receiving a screw, wherein rotation of the screw within the sleeve causes corresponding linear movement of the sleeve and thus movement of said loupe relative to said frame.

Preferably, the sleeve and screw arrangement is provided for infinite adjustment of said at least one loupe along said first axis and about said second and third axes.

It is often required that images are captured during a process or procedure and separate image data recording devices are required to be used and, where possible, separately mounted to the user, being fed by a dedicated battery pack. This further increases the mass required to be carried by the user, and also presents an issue in terms of where to mount not only the device itself, but also the battery pack.

Thus, in accordance with a second aspect of the present invention, there is provided a through-the-lens (TTL) adjustable binocular loupes device, comprising a head-mountable frame, a support element and at least one TTL loupe mounted on the support element, the device further comprising an optical recording device, such as a motion recorder, provided in or on said frame, preferably at or adjacent the bridge thereof.

Optionally, an image storage device may also be provided in or on the frame and/or the optical recording device may include a wireless transmitter for transmitting image data wirelessly to a remote data receiver.

Furthermore, a lighting device is often required to illuminate a working area. However, these typically have to be separately mounted with a remote battery pack to the user. Having a focal point of the emitted light beam off-centre can provide asymmetric shadows in the working area, which can be disadvantageous.

Thus, in a preferred embodiment of the present invention, there is provided a light-emitting element supported by the frame, beneficially pivotably movable in at least a superior-inferior direction. If an optical recording device is provided, the light-emitting element is beneficially mounted above, below or on top of the optical recording device.

Preferably, the loupes device comprises an electrical conductor for connecting a power supply to the optical recording device and/or the light-emitting element, the electrical conductor being mounted in or on the frame. The frame may also include means for receiving and supporting a power supply, such as a battery pack or the like. The frame may also incorporate means, such as a USB port or the like, for receiving a cable for transmitting image data to a receiver.

Beneficially, the frame may include a splash-guard and/or visor connector for receiving a removable splash-guard and/or visor, or the frame may fixedly incorporate such a splash guard and/or visor.

Embodiments of the present invention will now be described by way of examples only and with reference to the accompanying drawings, in which:

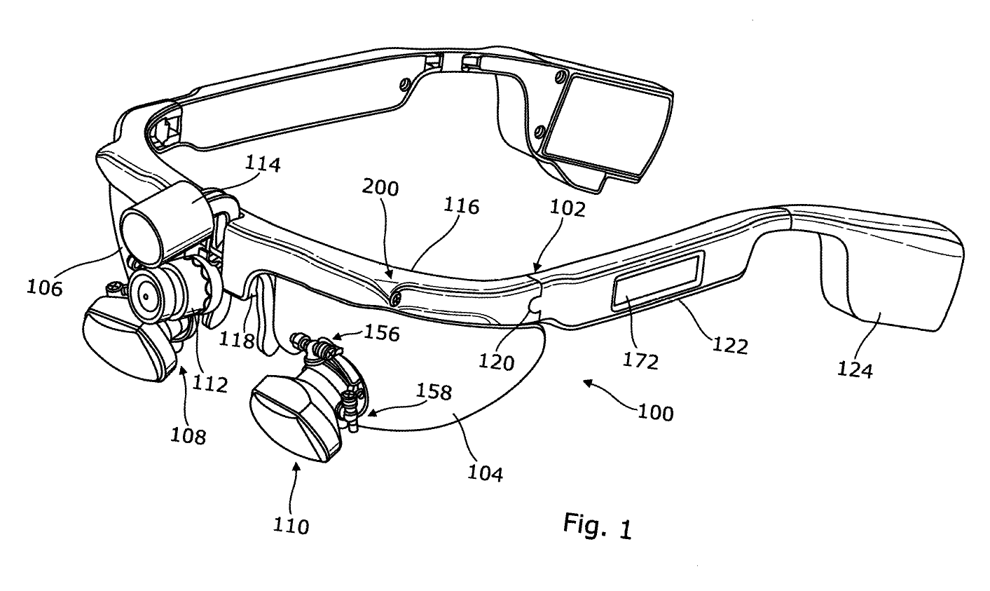

FIG. 1 is a perspective view of an adjustable binocular loupes device according to a first exemplary embodiment of the present invention;

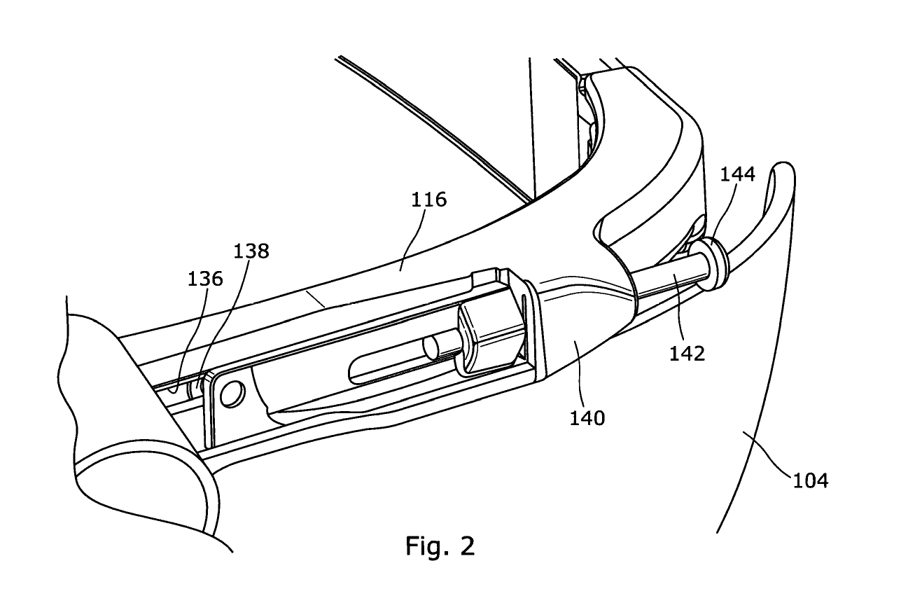

FIG. 2 is an expanded partial perspective view of the upper portion of one of the splash-guards, illustrating the infinite adjustment mechanism for effecting linear movement of an optical loupe relative to the frame;

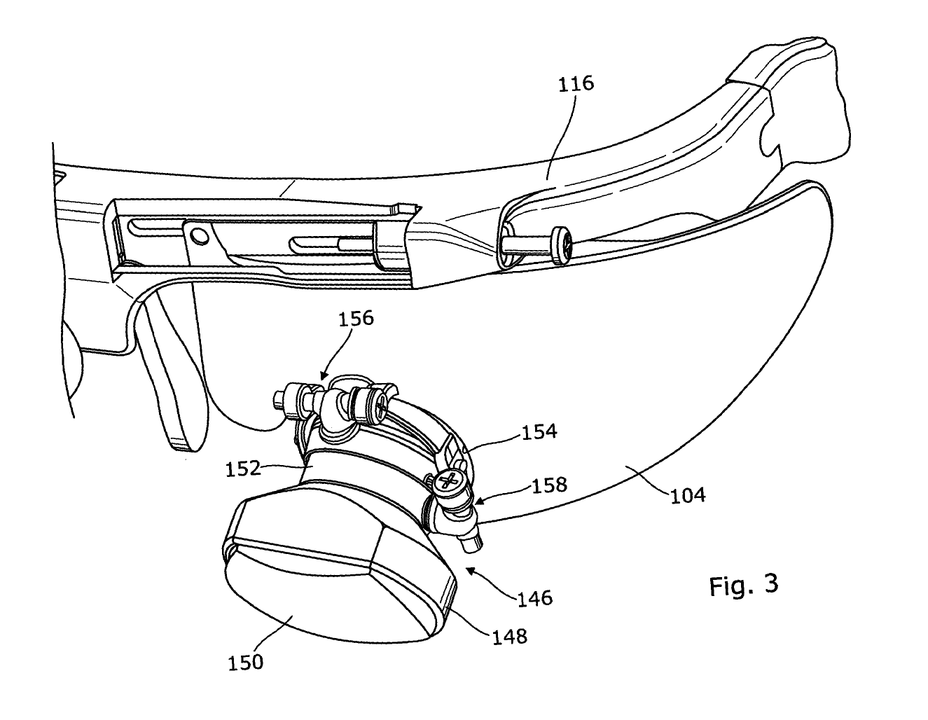

FIG. 3 is a partial perspective view of the device of FIG. 1, illustrating one of the support members and respective optical loupe device;

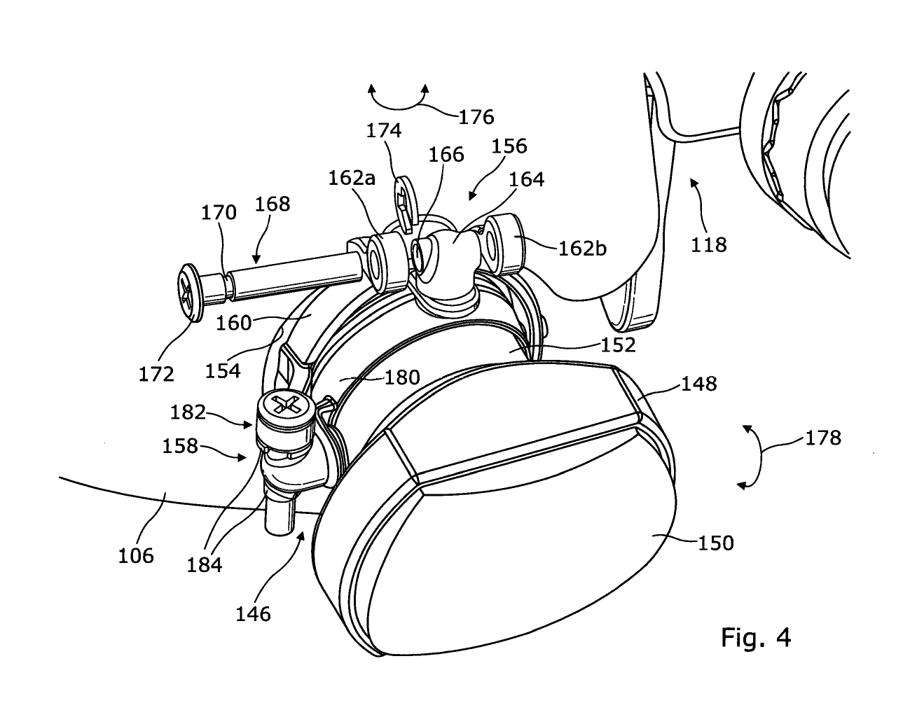

FIG. 4 is an expanded perspective view of one of the optical loupe devices;

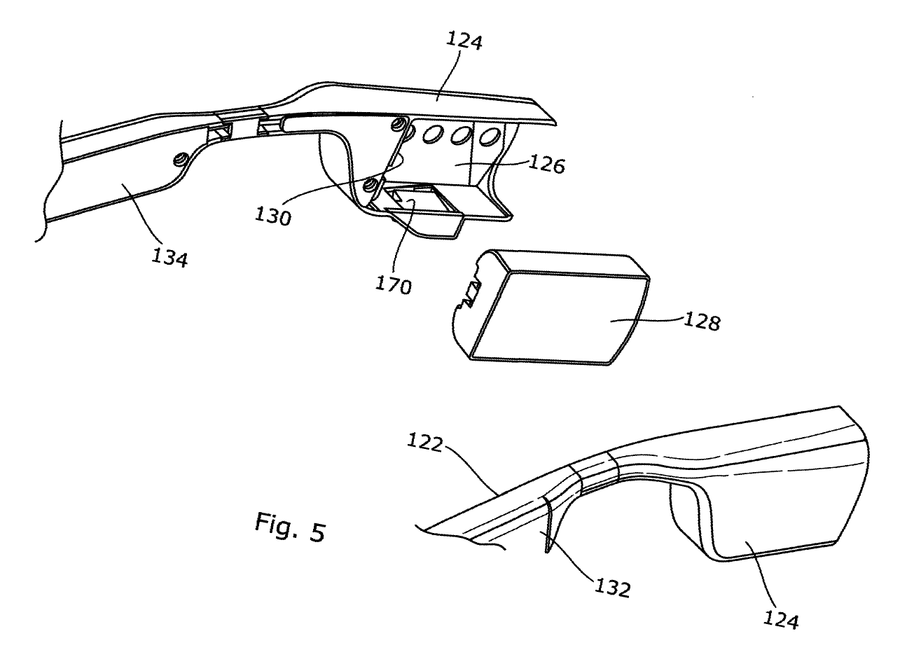

FIG. 5 is a partial perspective view of the arms of the frame of the binocular loupes device of FIG. 1;

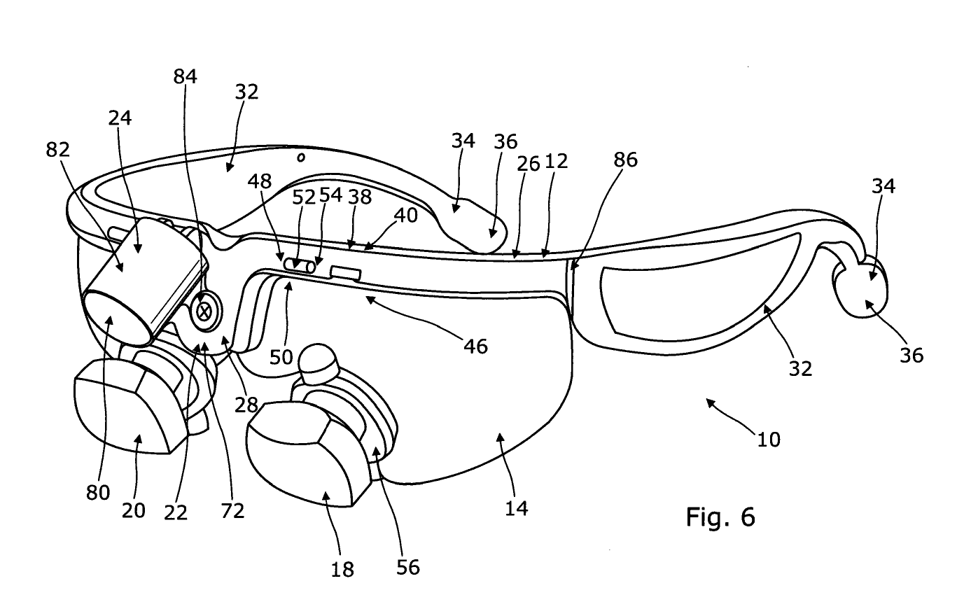

FIG. 6 shows a front-side perspective view of a second exemplary embodiment of the present invention;

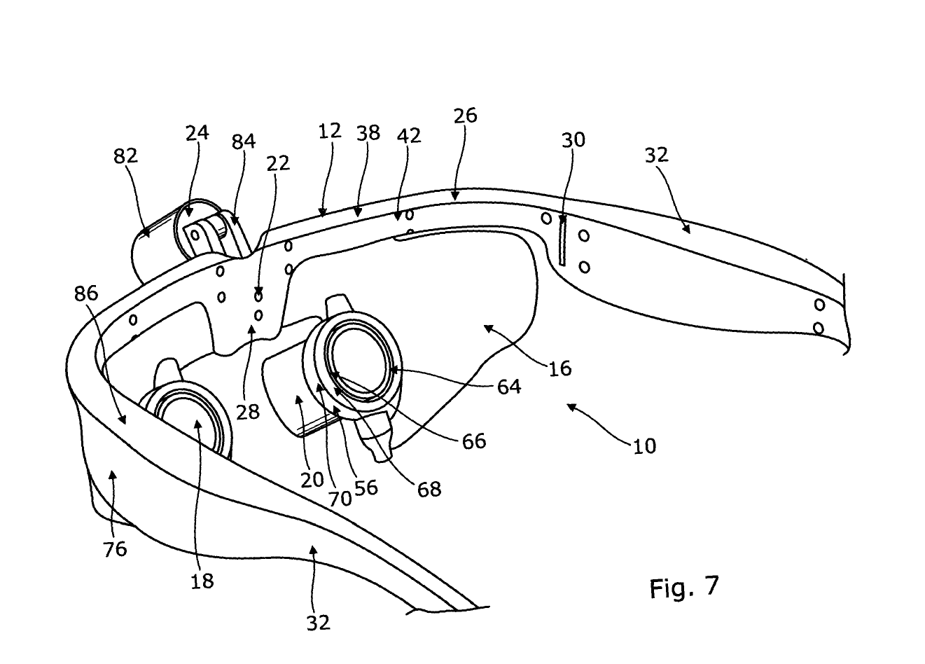

FIG. 7 shows a rear-side perspective view of the TTL adjustable binocular loupes device, shown in FIG. 6; and

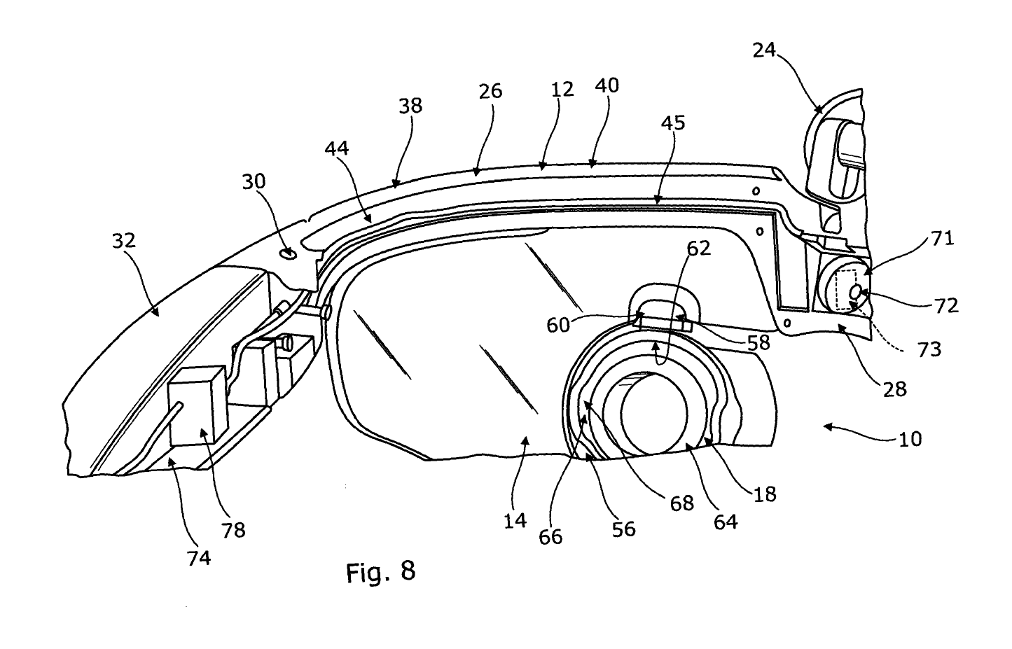

FIG. 8 shows an enlarged rear-side view of part of the TTL adjustable binocular loupes device, shown in FIG. 7 and with a rear part of a glasses frame removed.

Referring to FIG. 1 of the drawings, there is shown a perspective view of a first exemplary embodiment of a through-the-lens (TTL) adjustable binocular loupes device 100 which comprises a spectacle-like frame 102, first and second support elements 104, 106, first and second adjustable TTL loupe devices 108, 110, and optical recording device lens 112, and a light emitting element 114.

The spectacle-like frame 102 includes a rim 116 for holding the first and second support elements 104, 106, and a bridge 118 forming part of the rim 116 in this case which spans between the support elements 104, 106 for accommodating a user's nose. Lateral end portions of the rim 116 curve and terminate in hinges 120 to which proximal ends of arms 122 terminating in temples 124 are connected for pivoting movement. The temples 124 are receivable behind a user's ears. The hinges 120 are beneficial for compact storage, but are not necessarily essential.

Referring additionally to FIG. 5 of the drawings, at least one of the temples 124 comprises a compartment 126 for receiving a battery pack 128 integrally with the spectacle-like frame. The compartment 126, may also incorporate a USB port 170 or the like for connection to an external image data recorder, for transmitting images captured by the optical recording device to the external recording device, and also for enabling power to be supplied to the optical recording device. The optical recording lens 112 preferably has adjustable magnification means for selectively magnifying the subject.

To allow connection of the light emitting element 114 to the battery pack 128 within the compartment 126, electrical connectors 130 are provided on the inner wall of the compartment 126.

The rim 116 is preferably a two-part housing having a front housing part 132 and a rear housing part 134. The two-part housing 132, 134 defines an elongate internal cable conduit in which electrical conductors are receivable, The internal cable conduit extends from the electrical connectors 130 within the compartment 126, through the arms 122, via processing circuit boards, through the rim 116 to the bridge 118. Thus, the battery pack 128 supplies power to the light emitting element 114, whereas in this preferred embodiment, power is supplied to the optical recording device from an external sources, such as a computer, via the USB port 170. Images captured by the optical recording lens, are received by optical recording processing circuitry within the arm(s) 122, and then transmitted via the USB port 170 to an external image storage device, from which the images can, if required be uploaded to, for example, a central server for access by authorised operatives.

Processing circuitry within the arm(s) 122 also includes switching means, actuatable by an external button 172, for enabling the light emitting element 114 to be selectively switched on and off by the user, as required. The button 172 may be a pressure switch or an induction switch. The light emitting element preferably includes a lens for collimating light.

The first and second support elements 104, 106 may be transparent and may function as protective lenses for the eye region of the user. However, they may also be tinted and/or diffusing as required. Each of the first and second support elements 104, 106 is preferably at least in part curved in a medial to lateral direction relative to the glasses rim 116, to thereby generally follow the curvature of a user's head and thus provide improved protection to the eye region.

Referring to FIG. 2, there is shown a partial perspective view of the upper portion of one of the support elements 104, illustrating the infinite adjustment mechanism for effecting the linear movement of the support element 104, and therefore the respective loupe device 110 relative to the rim 116, for adjustment of the loupe for optimal optical characteristics according to the distance between the user's pupils. The support element 104 is slidably mounted on the frame rim 116, adjacent the bridge 118, within an elongate guide slot 136 via a rear mounted guide member 138. A sleeve member 140 having an inner screw-threaded surface receives a screw 142 having a groove (not shown) adjacent the head 144 thereof, and a circlip (not shown) is mounted within the groove. When the screw 142 is mounted within the sleeve 140, such that the circlip abuts the opening thereof, further linear movement of the screw into the sleeve is prevented by the circlip, and rotation of the screw instead causes linear movement of the sleeve, which in turn causes linear movement of the support element 104 along the guide slot 136 via the guide member 138. In use, the user rotates the screw to move the support element 104 and, therefore, the respective loupe device 108 to the desired linear position relative to the rim 116.

Referring to FIG. 3 of the drawings, there is shown a partial perspective view of one of the support elements 104, including a support member 146 carrying one of the loupe devices 108. The loupe support member 146 comprises a frame 148 carrying a loupe 150 and a neck portion 152 mounted within a correspondingly curved portion 154 of the support member 104. As shown, two further infinite adjustment mechanisms 156, 158 are provided on each loupe support member 146, to effect pivotal adjustment of the loupe 150 about the horizontal and vertical axes, relative to the rim 116. Each of the infinite adjustment mechanisms are similar in construction, and only one of these will be described in detail here.

Referring to FIG. 4 of the drawings, a substantially circular, flexible clip 160 surrounds the neck 152 of the loupe support member 146. The clip 160 is open at the top, and the ends of the opening are provided with threaded bolt members 162a, 162b. A mounting member 164 having a bore 166 is fixed at the top of the neck 152 of the loupe support member 146, between the threaded bolt members 162 such that the bolt members 162a, 162b and bore 166 together provide a sleeve for receiving a screw 168. The screw 168 comprises a groove 170 close to the head 172 thereof and a circlip 174 is mounted in the groove 170. When the screw 168 is mounted within the sleeve, such that the circlip 174 abuts the opening of the first bolt member 162a, further linear movement of the screw 168 into the sleeve is prevented by the circlip 174, and further rotation of the screw instead causes outward flexing of the circular clip 160. However, because relative movement of the clip 160 and the mounting member 164 is prevented by the screw 168 holding them together, this linear flexing of the circular clip 160 is translated into a pivotal movement of the loupe support member 146 relative to the support member 106, about the vertical axis, as illustrated by the arrow 176.

The construction and operation of the second infinite adjustment mechanism 158 is similar, except that the substantially circular clip 180 is mounted such that rotation of the screw 182 creates vertical flexing of the respective bolt members 184 and this linear movement is translated into pivotal movement of the loupe support member 146 within the support member 106, about the horizontal axis, as illustrated by the arrow 178.

Referring to FIGS. 6 to 8 of the drawings, there is shown a second exemplary embodiment of a through-the-lens (TTL) adjustable binocular loupes device 10 which comprises a glasses frame 12, first and second light-transmissible light support elements 14, 16, first and second adjustable TTL loupes 18, 20, an optical recording device 22, and a light emitting element 24.

The glasses frame 12 includes a rim 26 for holding the first and second light-transmissible support elements 14, 16 and a bridge 28 forming part of the rim 26 in this case which spans between the support elements 14, 16 for accommodating a user's nose. Lateral end portions of the rim 26 curve and terminate in hinges 30 to which proximal ends of temples 32 are connected for pivoting movement.

The temples 32 include temple tips 34 at their distal ends receivable behind a user's ears.

The aforementioned hinges 30 are beneficial for compact storage, but are not necessarily essential.

To allow connection to a power supply, typically being a battery pack which may be conveniently mountable at the back of a user's head via a strap which interconnects the two temples 32, electrical connectors 36 are provided at the distal ends of the temples 32. Conveniently, the electrical connectors 36 may be jacks, and are preferably integrated within the temples 32. The battery pack may include a twist-and-lock housing, to aid in removal and replacement. The glasses rim 26 is preferably a two-part housing 38 having a front housing part 40 and a rear housing part 42. The two-part housing 38 defines an elongate internal cable conduit 44 in which electrical conductors 45 are receivable. The internal cable conduit 44 extends from the electrical connectors 36 at the distal ends of the temples 32 to the bridge 28, as best shown in FIG. 8.

The first and second light transmissible elements 14, 16 are preferably transparent, and may function as visors for the eye region of a user instead of for ocular correction. However, the support elements 14, 16 may be tinted and/or diffusing as required.

Each of the first and second support elements 14, 16 is also preferably slidably mounted to the rim 26 of the glasses frame 12. As best seen in FIG. 6, an upwardly projecting tab 46 on each of the first and second support elements is slidably received in an elongate channel 48 in the rim 26 of the glasses frame 12. He channel 48 includes a lower slot 50 through which the upwardly projecting tab 46 is received, and also a front slot 52, as shown in FIG. 6. To allow adjustment of the interpupillary distance, each of the first and second support elements 14, 16 can be independently slid laterally and medially. Once a desired location is achieved, the upwardly projecting tabs 46 are held in place via suitable releasable fasteners 54, such as grub screws. Other holding means may be considered, such as a releasable rack and pawl mechanism or an indexing mechanism, thereby enabling adjustable non-screw-threaded engagement.

The first and second adjustable loupes 18, 20 are mounted on the first and second light-transmissible support elements 14, 16 respectively. A magnification of the loupes 18, 20 may be fixed, and thus generally bespoke to the user. However, adjustable magnification may be considered, for example, by utilising a telescopically adjustable lens system. Any magnification adjustment of each loupe may be independent of the other loupe, and/or an adjustment mechanism may be included which allows magnification adjustment in unison.

In this embodiment, each loupe 18, 20 is pivotably mounted on its respective support element 14, 16 so as to be rotatable to pan in a medial to lateral direction as well as pitch in an inferior to superior direction. To this end, each loupe 18, 20 comprises a mounting ring 56 which is pivotably connected to its respective support element 14, 16 on its polar axis. A first mounting interface 58 is preferably indexed, for example, using opposing sets of ramped interdigitatable teeth 60. Once the pan is pivotably adjusted in the lateral to medial direction, a further fastening device 62, again, such as a grub screw, can be utilised to releasably hold the mounting ring 56 stationary relative to the respective support element 14, 16.

Each loupe 18, 20 further comprises a lens body 64 which is pivotably mounted to its respective mounting ring 56 at the equatorial axis. A second mounting interface 66 similar to the first mounting interface 58 is preferably indexed, for example, using opposing sets of ramped interdigitatable teeth 68. Once the pitch is pivotably adjusted in the inferior to superior direction, a yet further fastening device 70, such as a grub screw, can be utilised to releasably hold the lens body 64 stationary relative to the respective mounting ring 56.

By way of further adjustability, it may be feasible that the lens body 64 includes longitudinal tracks, whereby the lens body 64 can slide relative to the second mounting interface 66 in a direction of the focal axis. Again, the lens body 64 would be held in place by engagement of the yet further fastening device 70.

To accommodate the optical recording device 22, the bridge 28 of the glasses frame 12 forms a recorder housing 71 having a lens aperture 72 in a front surface to accommodate a lens of the optical recording device 22. Recorder components and control circuitry 73 are provided in the recorder housing 71, and also as necessity dictates in a further recorder housing 74 provided in at least one of the temples 32. For example, a user interface 76, such as a switch, for energising and deenergising the optical recording device 22 may be provided on an outer surface of the temple 32 at or adjacent to the further recorder housing 74.

The optical recording device 22 may be a still image recorder or a motion image recorder.

Preferably, the recorder components 73 may include a wireless transmitter 78 for transmitting image data wirelessly to a remote data receiver. The remote data receiver may receive and display and/or store optical image data transmitted from the optical recording device 22. For example, the remote data receiver and display device may include a display screen for viewing the images in real time. Additionally or alternatively, the remote data receiver may be mounted on the user, for example, with or adjacent to the power supply, for storing the captured image data for post-procedure review.

Optionally, an electronic image data storage device may be provided on-board, and conveniently this may be located in or on the further recorder housing 74. Although preferably within the glasses frame 12, the further recorder housing 74 may include a data transfer port, such as a USB port, thereby allowing a removable data storage device to be connected and removed as required.

Although the first said recorder housing 38 is integrally formed as part of the glasses frame 12, and is therefore fixed stationary relative to the rim 26, the said first recorder housing 38 and/or recorder lens could be tiltable particularly for pitch in the inferior to superior direction. It would also be convenient if the said first recorder housing 38 and/or recorder lens incorporated pan adjustment through a rotatable mounting.

The light emitting element 24 is centrally mounted, preferably above, the optical recording device 22 at the bridge 28 of the glasses frame 12. The light emitting element 24 includes a light emitter 80, such as one or more LEDs, a light housing 82 in which the or each light emitter 80 is received, and a mounting shoe 84 which supports the light housing 82. The mounting shoe 84 is preferably pivotably engaged with the bridge 28 of the glasses frame 12, allowing tilting in an inferior to superior direction. It may also be beneficial to incorporate pivotably pan adjustment via the mounting shoe 84.

The mounting shoe 84 is preferably detachably supported by the bridge 28 of the glasses frame 12, and furthermore the light housing 82 is preferably detachable form the mounting shoe 84. This enables interchangability of components, as required.

The aforementioned electrical conductors 45 which pass through the glasses frame 12, extend to the bridge 28 of the glasses frame 12. The electrical conductors 45 connect with the optical recording device 22, and extend out of the bridge 28 to the light emitting element 24. With the power supply, such as the remote battery pack, connected, the optical recording device 22 and/or the light emitting element 24 can be energised via the user interface at the or each temple 32.

Although the power supply is remote, and in this case and by way of example, is provided as part of a rear head strap, the power supply may be incorporated as part of the glasses frame 12. For example, the power supply could be a removable battery pack provided within a battery housing formed in one or both temples 32.

Additionally, although the electrical conductors 45 are preferably conductive wires which extend through the internal cable conduit 44, it is feasible that one or more electrical conductors could be formed integrally with the glasses frame 12 as one-piece. The glasses frame 12 itself could be formed of electrically conductive material, thereby being the electrical conductor and dispensing with the need for separate electrical conductors 45 and thus wholly or in part the internal cable conduit 44.

The loupes device 10 further comprises a splash-guard connector 86 which is provided on the glasses frame 12. Conveniently, the splash-guard connector 86 may be integrally formed as part of the temples 32 of the glasses frame 12. The splash-guard connector 86 is provided as a releasable push-fit connector on an outer surface at the hinge region between the temple 32 and the rim 26 of the glasses frame 12. The splash guard is typically a large curved light-transmissible element with wing connectors at or adjacent to its upper edge. The wing connectors slot into the push-fit connectors 86 on the glasses frame 12, allowing the splash guard to be releasably held across the user's face and at least a majority of the loupes device 10.

Although mounted separately of the glasses frame, the light emitting element could be formed integrally with the glasses frame, in a similar manner to the optical recording device.

Furthermore, the optical recording device, although integrated as part of the glasses frame, could be provided on the exterior of the glasses frame, for example, together with the light emitting element.

However, it is preferable that the electrical conductors extend through the glasses frame to the bridge region to supply power to the light emitting element and the optical recording device.

The internal cable conduit preferably extends from both temple tips to the bridge. However, the internal cable conduit may only be required to extend from one temple tip to the bridge.

The light emitting element could be provided off-centre, for example, mounted to one or both temples.

It is thus possible to provide an aesthetically pleasing binocular loupes device which provides through-the-lens loupes mounting whilst also providing a great degree of adjustability to suit different users.

The embodiments described above are provided by way of examples only, and various other modifications will be apparent to persons skilled in the field without departing from the scope of the invention as defined by the appended claims.

1. A through-the-lens (TTL) adjustable binocular loupes device, comprising a head-mountable frame, a support element and at least one TTL loupe mounted on said support element and movable relative to said frame along a first axis between first and second limits, the device further comprising an infinite adjustment mechanism for moving said loupe to any desired position between said first and second limits, and means for fixing said loupe in said desired position.

2. A device according to claim 1, wherein said at least one loupe is linearly moveable relative to said frame along said first axis.

3. A device according to claim 1, wherein said at least one loupe is pivotable relative to said frame about a second axis between first and second limits, the device further comprising an infinite adjustment mechanism for moving said at least one loupe to any desired position between said first and second limits on said second axis, and means for fixing said loupe in said desired position.

4. A device according to claim 3, wherein said at least one loupe is pivotable about a third axis, substantially perpendicular to said second axis, between first and second limits the device further comprising an infinite adjustment mechanism for moving said at least one loupe to any desired position between said first and second limits on said third axis, and means for fixing said loupe in said desired position.

5. A device according to claim 1, comprising two TTL loupes, each linearly moveable along said first axis and/or pivotable about said second and third axes, the infinite adjustment mechanism being configured for moving each of said loupes to any desired position between said first and second limits on the or each of said respective axes and fixing said loupes in said respective desired positions.

6. A device according to claim 1, wherein the adjustment mechanism comprises a sleeve having an internal screw-threaded surface, the sleeve being connected to the at least one loupe and being mounted on said frame or support element for movement along one of said first, second or third axes, said sleeve comprising an opening for receiving a screw, wherein rotation of the screw within the sleeve causes corresponding linear movement of the sleeve and thus movement of said loupe relative to said frame.

7. A device according to claim 4, wherein the sleeve and screw arrangement of claim 6 is provided for infinite adjustment of said at least one loupe along said first axis and about said second and third axes.

8. A device according to claim 1, further comprising an optical recording device, provided in or on said frame.

9. A through-the-lens (TTL) adjustable binocular loupes device, comprising a head-mountable frame, a support element and at least one TTL loupe mounted on the support element, the device further comprising an optical recording device provided in or on said frame.

10. A device according to claim 9, wherein said optical recording device is provided in or on said frame, at or adjacent the bridge thereof.

11. A device according to claim 9, wherein an image storage device is provided in or on the frame.

12. A device according to claim 9, wherein the optical recording device includes a wireless transmitter for transmitting image data wirelessly to a remote data receiver.

13. A device according to claim 9, wherein the device comprises a port for connecting said optical recording device to an external data storage and/or processing means so as to enable power to be supplied to said optical recording device and/or image data captured by said optical recording device to be transmitted to said external means.

14. A device according to claim 9, further comprising a light-emitting element supported by the frame.

15. A device according to claim 14, wherein said light emitting element is pivotably movable in at least a superior-inferior direction.

16. A device according to claim 15, wherein the light-emitting element is mounted above, below or on top of the optical recording device.

17. A device according to claim 9, further comprising an electrical conductor for connecting a power supply to an optical recording device and/or a light-emitting element, the electrical conductor being mounted in or on the frame.

18. A device according to claim 9, further comprising means for receiving and supporting a power supply.

19. A device according to claim 9, including means for receiving a cable for transmitting image data to a receiver.

20. A device according to claim 9, further comprising a splash-guard connector for receiving a removable splash-guard and/or visor.

21. A device according to claim 9, wherein said frame fixedly incorporates a splash guard and/or visor.

22. (canceled)
